(19) United States
(12) Patent Application Publication
(10) Pub. No.: US 2026/0365086 A1
(43) Pub. Date: Nov. 19, 2026

(54) WALK-IN ADJUSTMENT DEVICES AND VEHICLE SEAT HAVING THE SAME

(71) Applicant: DAS CO., LTD, Gyeongju-si (KR)

(72) Inventors: Dong Gun LEE, Yongin (KR); Jang Woo BYUN, Yongin (KR); Kyung Soo OH, Yongin (KR); Song Min BAEK, Yongin (KR)

(21) Appl. No.: 19/421,186

(22) Filed: Dec. 16, 2025

(30) Foreign Application Priority Data
May 15, 2025 (KR) 10-2025-0062953

(51) Int. Cl. B60N 2/12; B60N 2/18

(52) U.S. Cl. CPC B60N 2/12; B60N 2/1839; B60N 2/1864; B60N 2/1892

(57) ABSTRACT

A walk-in adjustment device for a vehicle seat is disclosed. The device includes a moving rail slidably mounted to a fixed rail and a seat cushion frame having a front plate hinged to the moving rail and a rear plate hinged to the front plate. A seat back frame is rotatably mounted to the seat cushion frame. The device further includes a rear link with a sector gear part hinged to the moving rail and rotatably mounted to the rear plate. A locker arm engages the sector gear part, and a release bracket selectively locks or unlocks the locker arm. A stand-up lever is installed on the seat back frame, and a cable connects the stand-up lever to the release bracket.

### CROSS REFERENCE TO RELATED APPLICATION

The present application claims priority to Korea Patent Application No. 10-2025-0062953, filed May 15, 2025, the entire contents of which is incorporated herein for all purposes by this reference.

### FIELD

The present disclosure relates to a walk-in adjustment device, more particularly, a tilting-type walk-in adjustment device of a vehicular seat and a vehicular seat having the same.

### BACKGROUND

In general, a variety of convenient devices are provided in a driver seat, a passenger seat, and seats for other passengers, which are installed in the front and rear of a vehicle interior, for comfortableness of occupants.

The vehicular seat is configured to make use of an interior space of a vehicle by bringing a seat back into close contact with a seat cushion as close as possible. For example, the vehicular seat has a sliding function by which the vehicular seat can be adjusted by pushing and pulling the vehicular seat in forward and rearward directions according to a body type of a passenger, and a reclining function by which an inclination of a backrest (the seat back) can be adjusted. The sliding function is referred to as a walk-in function and the reclining function is referred to as a folding function.

The folding function is implemented through a recliner so that an angle of the seat back can be adjusted with respect to the seat cushion.

The walk-in function is implemented through a walk-in module mounted in the seat, and the walk-in module may operate in interrelation with the recliner through lever manipulation or may operate individually.

The above-described walk-in function is mainly used to secure an access way of a passenger in an SUV vehicle or a van of which an arrangement of seats consists of three-rows. That is, the walk-in function is performed such that the walk-in function is adjusted to push and pull a seat in a second row in forward and rearward directions so as to help in taking on and off of a passenger to a seat in a third row.

Meanwhile, the walk-in function generally takes the form in which a seat as a whole can be moved in forward and rearward directions in a state in which the seat back of the seat is folded in the seat cushion.

However, the above-described walk-in function has a limitation in securing an area of the access way.

To this end, the applicant has proposed a technology of Korea Patent No. 10-2024-0076912 (May 31, 2024) so that a wider area of the access way can be secured.

The proposed technology is a tilting-type walk-in adjustment device of a vehicular seat, and is characterized in that it enables the seat cushion to be tilted while making a seat back of a vehicle rotate forward and be stood up in the walk-in function operation.

### PRIOR ART DOCUMENT

### Patent Document

(Patent Document 1) Korean Patent No. 10-2024-0076912 (May 25, 2024)

### SUMMARY

The present disclosure is tilting-type walk-in adjustment device, and a technical problem of the present disclosure is to provide a further improved walk-in adjustment device of a vehicular seat capable of implementing a walk-in function precisely and rapidly with a simple mechanism and the reduced number of parts, and a vehicular seat including the same.

One embodiment is a walk-in adjustment device for a vehicular seat, including: a moving rail movably installed to a fixed rail; a seat cushion frame comprising a front plate hingedly coupled to a forward portion of the moving rail and a rear plate having one side hingedly coupled to the front plate; a seat back frame rotatably installed to the seat cushion frame; a rear link comprising one side having a sector gear part rotatably installed to a rear plate and another side hingedly coupled to a rearward portion of the moving rail; a locker arm engaged with the sector gear part of the rear link and rotatably installed to the rear plate; a release bracket selectively engaged with the locker arm such that the locker arm is locked or unlocked and rotatably mounted in the rear plate; a stand-up lever installed to the seat back frame; and a cable configured to connect the stand-up lever and the release bracket to each other.

The rear link may include: a horizontal link rotatably installed to the rear plate; and a vertical link extending from the horizontal link and having an end in which the sector gear part is provided.

The sector gear part may include: a first sector gear engaged with the locker arm; a second sector gear engaged with the locker arm when the rear link pivots; and a connection protrusion configured to connect the first sector gear and the second sector gear to each other.

The locker arm may include: a locking gear engaged with the sector gear part; a stopper configured to limit a movement range of the release bracket; a locking protrusion configured to be selectively in contact with the release bracket; and an unlock groove recessed between the stopper and the locking protrusion.

The release bracket may include: a release protrusion configured to be selectively in contact with the locking protrusion and the unlock groove; and a cable connecting portion configured to rotate the release bracket while being connected to the cable.

The walk-in adjustment device for a vehicular seat may further include: a cover bracket configured to allow the rear link, the locker arm, and the release bracket to be coupled to a rotational shaft.

The walk-in adjustment device for a vehicular seat may further include: a return portion having one side fixed to the moving rail and another side fixed to the rear plate.

The return portion may include: a first fixing pin installed to the rear plate; a second fixing pin installed to the moving rail; and a coil spring installed to the first fixing pin and the second fixing pin.

Meanwhile, the present disclosure provides a vehicular seat, including: a walk-in adjustment device for a vehicular seat according to one of claims 1 to 8.

According to the walk-in adjustment device of a vehicular seat and a vehicular seat including the same, it is possible to precisely and rapidly implement the tilting walk-in function through a simple mechanism of which locking/unlocking is made through an externally toothed locking module and with the reduced number of conventional parts such as a latch, a striker, and the like.

In addition, the present disclosure has a structure which is applicable to both seats in a first row and seats in a second row, and may maximize a space of walk-in through and the luggage.

### BRIEF DESCRIPTION OF THE DRAWINGS

FIG. 1 is an exploded perspective view with respect to a main part of a vehicular seat in which a walk-in adjustment device according to an embodiment of the present disclosure is installed.

FIG. 2 is an enlarged view of a seat back frame region in which a stand-up lever of FIG. 1 is mounted.

FIG. 3 is a perspective view with respect to a walk-in adjustment device of FIG. 1 when a vehicular seat is viewed in an opposite direction.

FIG. 4 is an enlarged view of a main part of FIG. 3.

FIG. 5 is a side view of a vehicular seat, in which a walk-in adjustment device according to an embodiment of the present disclosure is installed, before a walk-in operation.

FIG. 6 shows a progress of a walk-in mode of FIG. 5, and a state in which a seat back maintains a stood-up state and a seat cushion rotates and stands up as a seat partially moves forward.

FIG. 7 is an enlarged view with respect to a main part of FIG. 6.

FIG. 8 shows a state in which a walk-in mode of FIG. 6 is completed, and a state in which a seat moves forward, and standing up of a seat back and a seat cushion is completed.

FIG. 9 is an enlarged view of a main part of FIG. 8.

### DETAILED DESCRIPTION

Hereinafter, some embodiments of the present disclosure will be described in detail with reference to exemplary drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

In the description of the present disclosure, the terms such as “first” and “second” may be used to describe various components, but the components should not be limited by the terms. These terms are used only to distinguish one component from another component. For example, a first component may be named a second component, and similarly, the second component may also be named the first component, without departing from the scope of the present disclosure.

The term “and/or” may include any and all combinations of a plurality of the related and listed items.

When one component is described as being “coupled” or “connected” to another component, it should be understood that one component can be coupled or connected directly to another component, and an intervening component can also be present between the components. When one component is described as being “coupled directly to” or “connected directly to” another component, it should be understood that no intervening component is present between the components.

The terminology used herein is used for the purpose of describing particular embodiments only and is not intended to limit the present disclosure. Singular expressions may include plural expressions unless clearly described as different meanings in the context.

The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof.

Unless otherwise defined, all terms used herein, including technical or scientific terms, may have the same meaning as commonly understood by those skilled in the art to which the present disclosure pertains.

The terms such as those defined in a commonly used dictionary may be interpreted as having meanings consistent with meanings in the context of related technologies and may not be interpreted as ideal or excessively formal meanings unless explicitly defined in the present application.

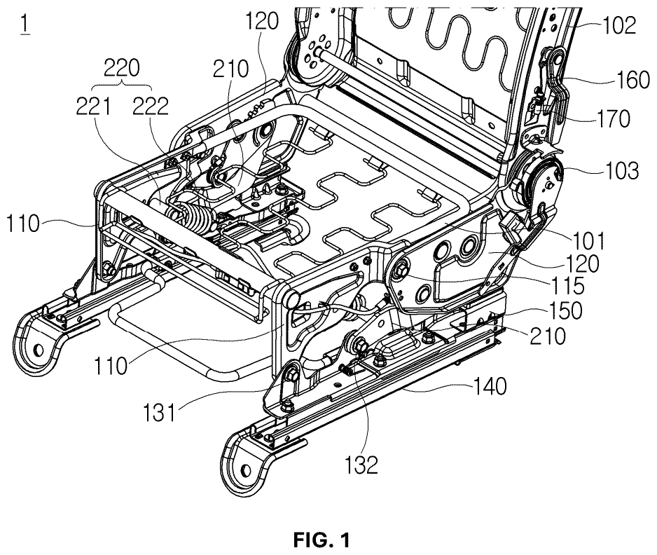

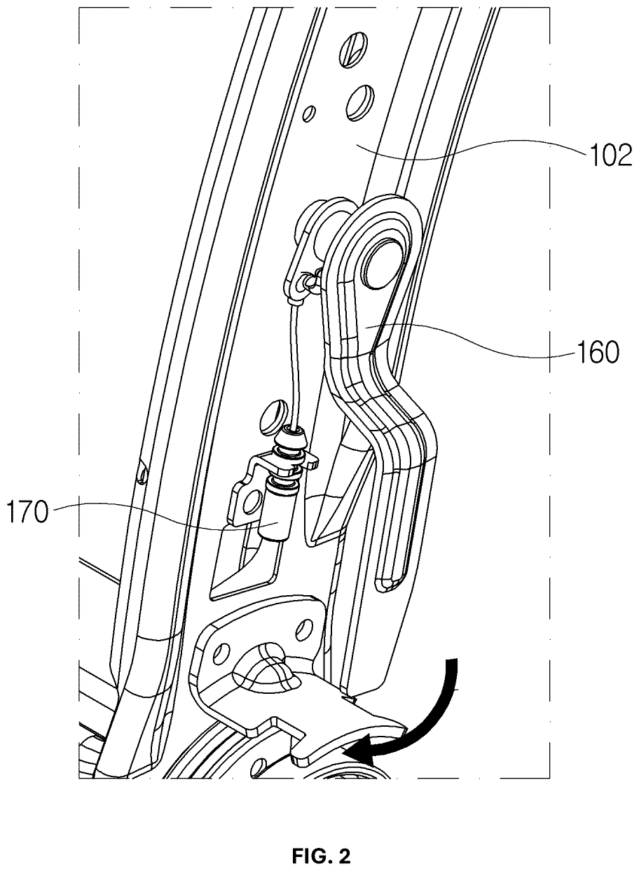

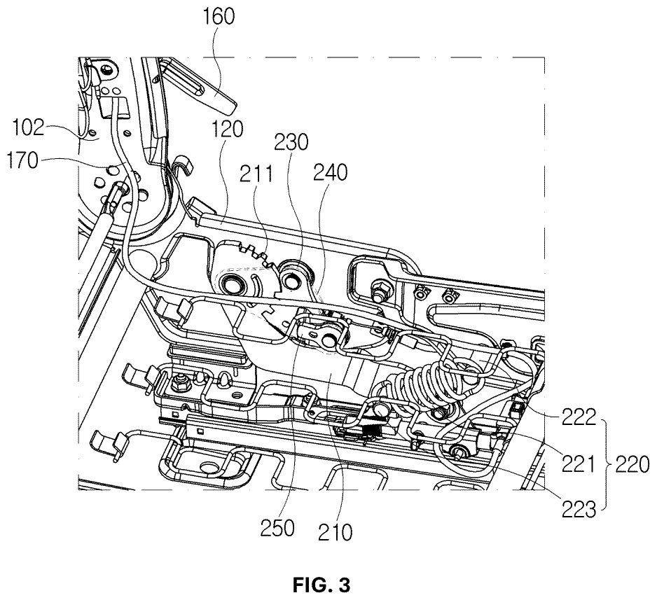

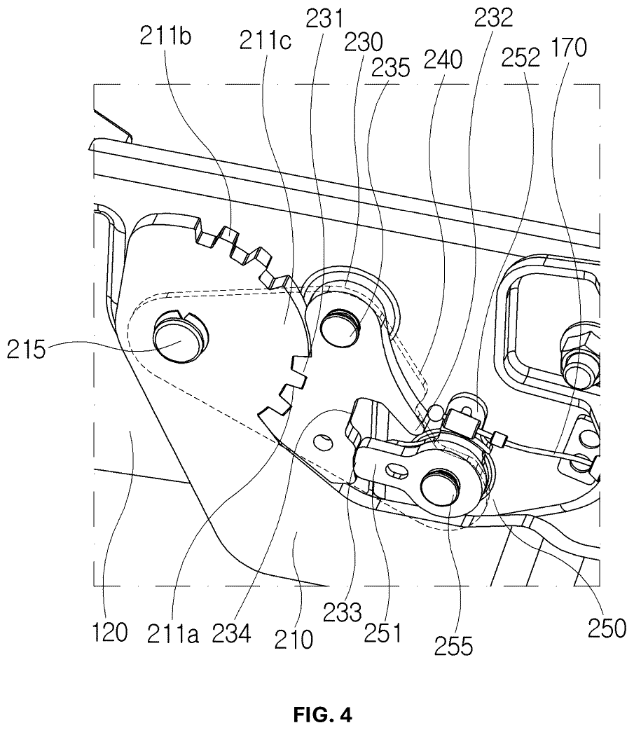

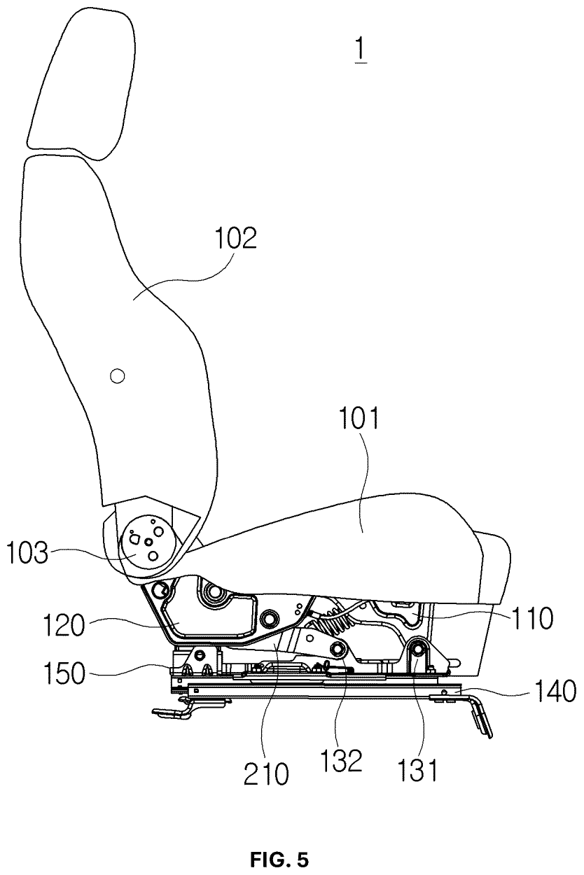

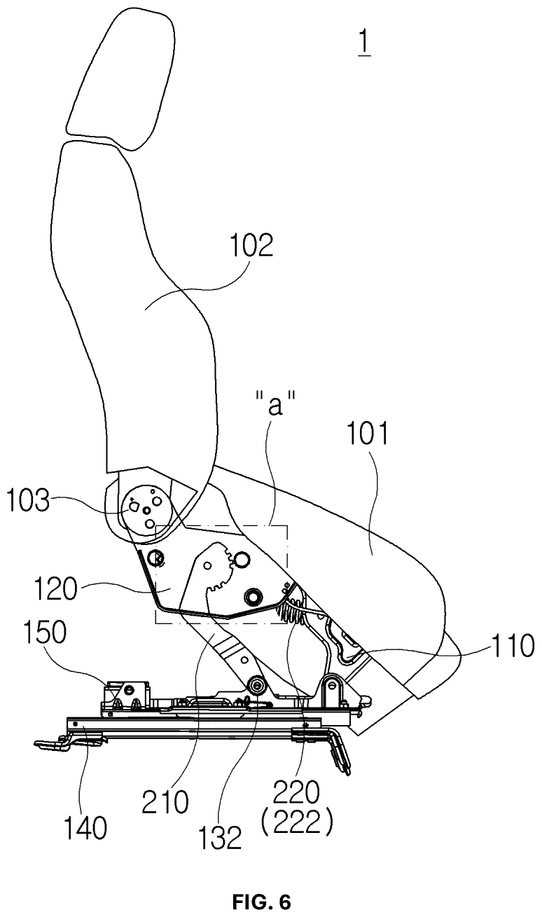

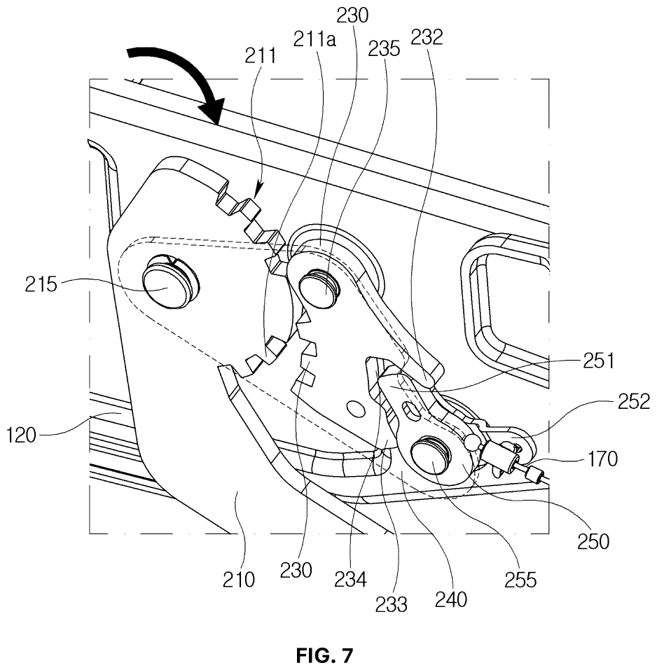

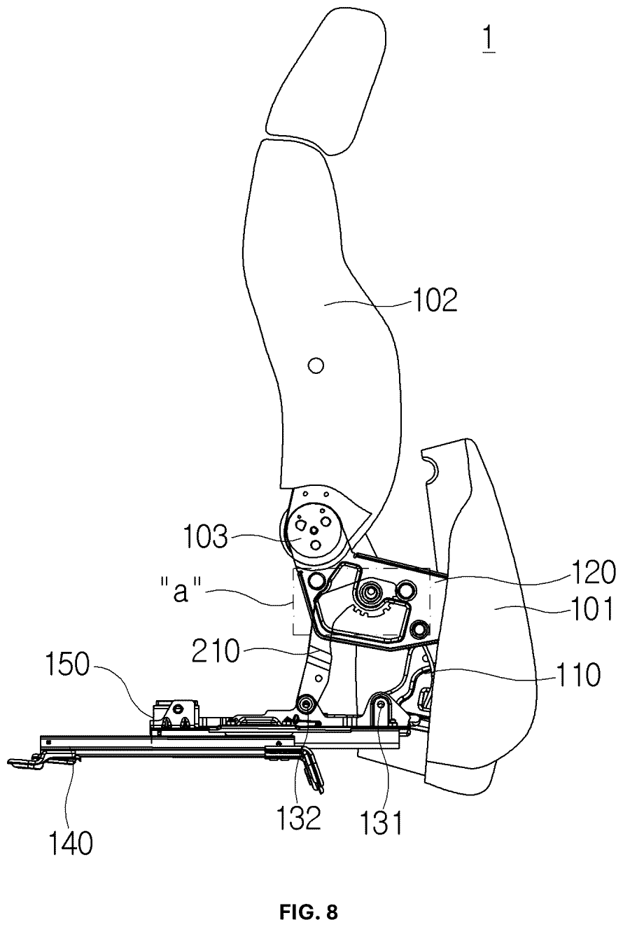

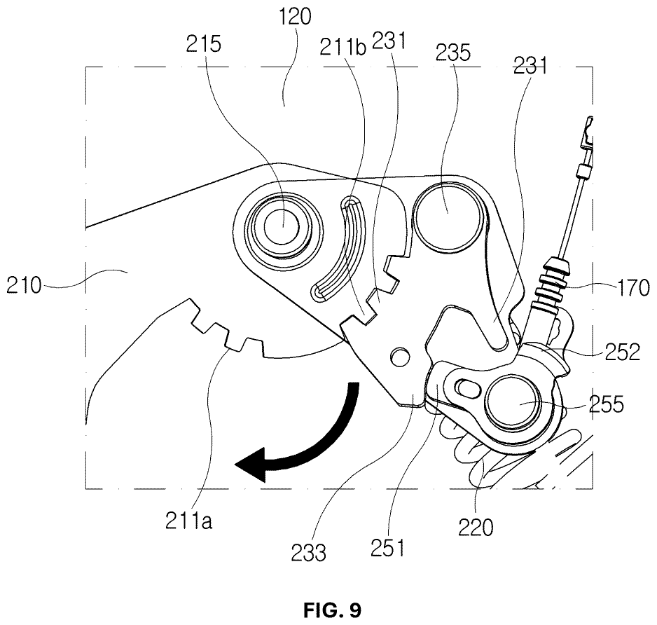

FIG. 1 is an exploded perspective view with respect to a main part of a vehicular seat in which a walk-in adjustment device according to an embodiment of the present disclosure is installed, FIG. 2 is an enlarged view of a seat back frame region in which a stand-up lever of FIG. 1 is mounted, FIG. 3 is a perspective view with respect to a walk-in adjustment device of FIG. 1 when a vehicular seat is viewed in an opposite direction, FIG. 4 is an enlarged view of a main part of FIG. 3, FIG. 5 is a side view of a vehicular seat, in which a walk-in adjustment device according to an embodiment of the present disclosure is installed, before a walk-in operation, FIG. 6 shows a progress of a walk-in mode of FIG. 5, and a state in which a seat back maintains a stood-up state and a seat cushion rotates and stands up as a seat partially moves forward, FIG. 7 is an enlarged view with respect to a main part of FIG. 6, FIG. 8 shows a state in which a walk-in mode of FIG. 6 is completed, and a state in which a seat moves forward, and standing up of a seat back and a seat cushion is completed, and FIG. 9 is an enlarged view of a main part of FIG. 8.

Referring to FIGS. 1 to 9, the vehicular seat 1 of the present embodiment may largely include a fixed rail 140, a moving rail 150, a seat cushion frame 101, a seat back frame 102, and a recliner 103.

The fixed rail 140 may be installed as a pair on a floor surface of a vehicle. A pair of moving rails 150 is installed in the pair of fixed rails 140, respectively. The moving rail 150 is movably installed to the fixed rail 140, and may support the seat cushion frame 101.

Therefore, the fixed rail 140 and the moving rail 150 are installed such that they can move a seat cushion 101a (refer to FIG. 5) and a seat back 102a (refer to FIG. 5) forward and rearward, that is, a linear direction.

The seat cushion frame 101 forms a horizontal frame which enables the seat cushion 101a (refer to FIG. 5) to be installed therein, and may include various parts.

For example, the seat cushion frame 101 forms a front plate 110 hingedly coupled to a forward portion of the moving rail 150, and a rear plate 120 having one side hingedly coupled to the front plate 120.

Here, the front plate 110 and the rear plate 120 may be pivotably coupled to each other by a hinge shaft 115. The front plate 110 and the rear plate 120 are coupled to each other and may configure a base plate of the seat cushion frame 101.

The seat back frame 102 may be rotatably installed to the seat cushion frame 101, and may form a vertical frame which enables the seat back 102a (refer to FIG. 5) to be installed therein.

The seat back frame 102 and the seat cushion frame 101 may be coupled to each other such that an angle of each of them is adjusted through a recliner 103 and a recliner shaft.

Meanwhile, the vehicular seat 1 of an embodiment is a tilting-type walk-in adjustment device, and may include a rear link 210, a locker arm 230, a release bracket 250, a stand-up lever 160, and a cable 170, etc. Here, the rear link 210, the locker arm 230, the release bracket 250, the stand-up lever 160, and the cable 170 may be referred to as an externally toothed locking module.

Referring to FIGS. 3 and 4, the rear link 210 may have a sector gear part 211 rotatably installed to the rear plate 120, and another side hingedly coupled to a rear portion of the moving rail 150 through a second hinge shaft 132.

The forward portion of the moving rail 150 is hingedly coupled to the front plate 110 and a first hinge shaft 131. The front plate 110 may have a short movement range through the first hinge shaft 131, and the rear plate 120 may have a great movement range through the second hinge shaft 132 and the rear link 210.

That is, the front plate 110, the rear plate 120, the rear link 210, and the moving rail 150 of the seat cushion frame 101 may implement a walk-in operation of the seat in a tilting type, while forming a four-bar link form.

To this end, the rear link 210 may include a horizontal link 210a rotatably installed to the rear plate 120, and a vertical link 210b extending from the horizontal link 210a and an end at which the sector gear part 211 is provided. That is, the rear link 210 may have an L-shape.

Because of such a form of the rear link 210, as illustrated in FIG. 5, the rear link 210 may support the seat cushion 101a to get into a horizontal state, and as illustrated in FIG. 8, may support the seat cushion 101a to get into a vertical state (stood up state).

Referring to FIG. 4, the sector gear part 211 of the rear link 210 may include a first sector gear 211a engaged with the locker arm 230, a second sector gear 211b engaged with the locker arm 230 when the rear link 210 pivots, and a connection protrusion 211c configured to connect the first sector gear 211a and the second sector gear 211b to each other.

The sector gear part 211 may have a semi-arc shape, and may be rotatably installed to the rear plate 120 to be adjacent to the locker arm 230 through a rotational shaft 215.

The locker arm 230 may be engaged with the sector gear part 211 of the rear link 210, and may be rotatably installed to the rear plate 120 through a rotational shaft 235.

In more detail, the locker arm 230 may include a locking gear 231 engaged with the sector gear part 211, a stopper 232 configured to limit a movement range of the release bracket 250, a locking protrusion 233 configured to be selectively in contact with the release bracket 250, and an unlock groove 234 recessed between the stopper 232 and the locking protrusion 233.

The locking gear 231 may be positioned on one side (a left side) of the locker arm 230, and the stopper 232, the locking protrusion 233, and the unlock groove 234 may be positioned on another side (a right side) of the locker arm 230.

The release bracket 250 may be selectively engaged with the locker arm 230 so that the release bracket 250 locks or unlocks the locker arm 230, and may be rotatably mounted in the rear plate 230 through a rotational shaft 255.

In addition, the release bracket 250 may include a release protrusion 251 configured to be selectively in contact with the locking protrusion 233 and the unlock groove 234, and a cable connecting portion 252 configured to rotate the release bracket 250 while being in contact with the cable 170.

For example, the release protrusion 251 may have a protrusion shape protruding to be elongated in one direction with respect to the rotational shaft 255.

The cable connecting portion 252 may be positioned to have an inclined angle with the release protrusion 251.

When the cable connecting portion 252 is pulled by the cable 170, the release bracket 250 may rotate with respect to the rotational shaft 255 and may change a position of the release protrusion 251.

Therefore, as illustrated in FIGS. 4 and 9, the release protrusion 251 may be in contact with the locking protrusion 233 of the locker arm 230, and as illustrated in FIG. 7, the release protrusion 251 may be engaged with the unlock groove 234 of the locker arm 230.

The walk-in adjustment device of a vehicular seat of the present disclosure may further include a cover bracket 240 coupled to each of the rotational shafts 215, 235 and 255 of the rear link 210, the locker arm 230, and the release bracket 250 which have been described above. The cover bracket 240 may serve to prevent breakaway of the above-described parts and protect the above-described parts.

The stand-up lever 160 may be installed in the seat back frame 102. The stand-up lever 160 may be manipulated so that the stand-up lever 160 may be pulled or pushed by a user. The stand-up lever 160 may allow entry into or exit from the tilting type walk-in mode of the vehicular seat while being in communication with the cable 170.

The cable 170 may connect the stand-up lever 160 and the release bracket 250 to each other, and transmit an operation of the stand-up lever 160 to the release bracket 250, thereby controlling the operation of the stand-up lever 160. That is, the release bracket 250 may lock or unlock the locker arm 230.

Meanwhile, the walk-in adjustment device of a vehicular seat of the present disclosure may further include a return portion 220 having one side fixed to the moving rail 150 and another side fixed to the rear plate 120.

The return portion 220 may provide propulsive force so that the seat 1 of the vehicle can easily return to a normal mode from the tilting walk-in mode.

Referring to FIG. 3, the return portion 220 may include a first fixing pin 222 installed to the rear plate 120, a second fixing pin 223 installed to the moving rail 150, and a coil spring 221 installed to the first fixing pin 222 and the second fixing pin 223.

Referring to the above-described drawings, an operation of the walk-in adjustment device of a vehicular seat and a vehicular seat including the same which includes the above-described components will be described.

As illustrated in FIG. 5, in a state in which a position of the seat 1 is fixed (locked) at usual time, when manipulating the stand-up lever 160 mounted in the seat-back frame 102 as illustrated in FIG. 2, the cable 170 rotates the release bracket 250, thereby entering the tilting walk-in mode.

That is, as illustrated in FIG. 4, in a state in which the seat is locked, a release protrusion 251 of the release bracket 250 maintains a state in which it is in contact the locking protrusion 233 of the locker arm 230. At this instance, a first sector gear 211b of the rear link 210 and the locking gear 231 of the locker arm 230 are engaged with each other.

When the stand-up lever 160 is manipulated for the tilting walk-in mode, as illustrated in FIG. 7, as the cable 170 pulls the cable connecting portion 252 of the release bracket 250, the release protrusion 152 of the release bracket 250 is engaged with the unlock groove 234 of the locker arm 230, thereby the locking is released.

Therefore, when the user pushes the seat back 102a forward (a right side in the drawing), as illustrated in FIG. 6, the moving rail 150 and the seat back 102a move, the seat cushion 101a is lifted gradually, and as illustrated in FIG. 9, the seat cushion 101a is stood up completely in a vertical direction.

Here, according to a shape and a structure of the rear link 210, the rear plate 120 rotates with respect to the rotational shaft 115 and is folded with respect to the front plate 110 (refer to FIGS. 6 and 8).

As illustrated in FIG. 8, in a state in which tilting walk-in of the seat back 102a and the seat cushion 101a is completed, the rear link 210 supports the seat back 102a and the seat cushion 101a, while locking them.

In more detail, as the second sector gear 211b of the rear link 210 and the locking gear 231 of the locker arm 230 are engaged with each other and the release protrusion 251 of the release bracket 250 is in contact with the locking protrusion 234 of the locker arm 230, locking may be maintained.

As such, according to the walk-in adjustment device of a vehicular seat and a vehicular seat having the same of the present disclosure, a tilting walk-in operation can be precisely and rapidly implemented by a simple mechanism by which locking and unlocking is performed through the externally toothed locking module, while reducing the number of conventional parts such as a latch, a striker, and the like.

In addition, the above-described disclosure has a structure which can be applied to both the first row and the second row of the vehicle and may maximize a space of walk-in through and the luggage.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

### REFERENCE NUMERALS

1: vehicular seat
101: seat cushion (frame)
102: seat back (frame)
110: front plate
115: hinge shaft
120: rear plate
131: first hinge shaft
132: second hinge shaft
140: fixed rail
150: moving rail
160: stand-up lever
170: cable
210: rear link
210a: horizontal link
210b: vertical link
211: sector gear part
211a: first sector gear
211b: second sector gear
211c: connection protrusion
215: rotational shaft
220: return portion
221: coil spring
222, 223: fixing pin
230: locker arm
231: locking gear 232: stopper
233: locking protrusion
234: unlock groove
235: rotational shaft
240: cover bracket
250: release bracket
251: release protrusion
255: rotational shaft

What is claimed is:

1. A walk-in adjustment device for a vehicular seat, comprising:
a moving rail movably installed to a fixed rail;
a seat cushion frame comprising a front plate hingedly coupled to a forward portion of the moving rail and a rear plate having one side hingedly coupled to the front plate;
a seat back frame rotatably installed to the seat cushion frame;
a rear link comprising one side having a sector gear part rotatably installed to a rear plate and another side hingedly coupled to a rearward portion of the moving rail;
a locker arm engaged with the sector gear part of the rear link and rotatably installed to the rear plate;
a release bracket selectively engaged with the locker arm such that the locker arm is locked or unlocked and rotatably mounted in the rear plate;
a stand-up lever installed to the seat back frame; and
a cable configured to connect the stand-up lever and the release bracket to each other.

2. The walk-in adjustment device for a vehicular seat of claim 1,
wherein the rear link comprises:
a horizontal link rotatably installed to the rear plate; and
a vertical link extending from the horizontal link and having an end in which the sector gear part is provided.

3. The walk-in adjustment device for a vehicular seat of claim 1,
wherein the sector gear part comprises:
a first sector gear engaged with the locker arm;
a second sector gear engaged with the locker arm when the rear link pivots; and
a connection protrusion configured to connect the first sector gear and the second sector gear to each other.

4. The walk-in adjustment device for a vehicular seat of claim 1,
wherein the locker arm comprises:
a locking gear engaged with the sector gear part;
a stopper configured to limit a movement range of the release bracket;
a locking protrusion configured to be selectively in contact with the release bracket; and
an unlock groove recessed between the stopper and the locking protrusion.

5. The walk-in adjustment device for a vehicular seat of claim 4,
wherein the release bracket comprises:
a release protrusion configured to be selectively in contact with the locking protrusion and the unlock groove; and
a cable connecting portion configured to rotate the release bracket while being connected to the cable.

6. The walk-in adjustment device for a vehicular seat of claim 1, further comprising:
a cover bracket configured to allow the rear link, the locker arm, and the release bracket to be coupled to a rotational shaft.

7. The walk-in adjustment device for a vehicular seat of claim 1, further comprising:
a return portion having one side fixed to the moving rail and another side fixed to the rear plate.

8. The walk-in adjustment device for a vehicular seat of claim 7,
wherein the return portion comprises:
a first fixing pin installed to the rear plate;
a second fixing pin installed to the moving rail; and
a coil spring installed to the first fixing pin and the second fixing pin.

9. A vehicular seat, comprising:
a walk-in adjustment device for a vehicular seat according to claim 1.
